(19) United States
(12) Patent Application Publication
(10) Pub. No.: US 2021/0333672 A1
(43) Pub. Date: Oct. 28, 2021

(54) LIQUID CRYSTAL DISPLAY PANEL AND LIQUID CRYSTAL DISPLAY DEVICE

(71) Applicant: Shenzhen China Star Optoelectronics Semiconductor Display Technology Co., Ltd., Shenzhen (CN)

(72) Inventor: Wu CAO, Shenzhen (CN)

(73) Assignee: Shenzhen China Star Optoelectronics Semiconductor Display Technology Co., Ltd., Shenzhen (CN)

(21) Appl. No.: 16/627,395

(22) PCT Filed: Dec. 16, 2019
(86) PCT No.: PCT/CN2019/125577

§ 371 Date: Dec. 30, 2019

(30) Foreign Application Priority Data
Oct. 29, 2019 (CN) 201911036170.4

(51) Int. Cl. G02F 1/1362

(52) U.S. Cl. CPC G02F 1/136286; G02F 1/136209

(57) ABSTRACT

A liquid crystal display panel is provided, which includes a first substrate provided with scan lines and data lines crossing to each other to define a plurality of pixel units. Each of the pixel units includes a common electrode, a pixel electrode, and a black matrix replacement electrode, and the black matrix replacement electrode is disposed above the corresponding data line to shield the corresponding data line and insulated from the corresponding data line; a second substrate aligned with the first substrate, wherein a black matrix is arranged on the second substrate; and a liquid crystal layer disposed between the first substrate and the second substrate.

### FIELD OF INVENTION

The present invention relates to the technical field of display panels, and in particular, to a liquid crystal display panel and a liquid crystal display device.

### BACKGROUND OF INVENTION

Liquid crystal displays (LCDs) have been widely used in mobile phones, televisions, personal digital assistants, digital cameras, notebook computers, and other consumer electronics because of their advantages such as image high quality, power saving, thin body, and wide application range, and have become the mainstream in display devices.

In the early technology without a color filter layer disposed on a color filter substrate (NonCOA), please refer to FIG. 1, which includes a lower substrate 110 and an upper substrate 120. The lower substrate 110 is sequentially provided with common electrodes 111, an insulating layer 112, data lines 113, a second insulating layer 114, and pixel electrodes 115 from bottom to top. The upper substrate 120 is provided with first sub-pixels 122, second sub-pixels 123, and a black matrix (BM) 121. In order to prevent color mixing and color shift, a light-shielding band is needed at the data line 113 that distinguishes each sub-pixel, that is, a wide black matrix 121 is required for isolation, which causes unfriendly aperture ratio or transmittance. At the same time, when the upper and lower substrates are aligned, for the consideration of covering a part of accuracy of the alignment shift, the BM needs to be further increased.

In order to save the aperture ratio, VA-type LCD technology develops a COA (color filter layer is arranged on an array substrate) architecture. Also, in order to remove the black matrix, data line BM Less (DBS) electrodes are used for light-shielding. Please refer to FIG. 2 for details, where includes a lower substrate 210 and an upper substrate 220. The lower substrate 210 is sequentially provided with common electrodes 211, a first insulating layer 212, data lines 213, a second insulating layer 214, first sub-pixels 215, second sub-pixels 216, a third insulating layer 217, pixel electrodes 218, and DBS electrodes 219 from bottom to top. Because the DBS electrodes and the common electrodes of the upper substrate are equipotential input, where a voltage difference is small and the VA liquid crystal does not collapse, so it is kept dark normally, and the light-shielding is realized. However, in this design, there is a low-efficiency liquid crystal region, which is not beneficial to the improvement of contrast.

### Technical Problem

Present NonCOA architecture, a wider black matrix is needed to prevent color mixing, which causes unfriendly aperture ratios or transmittance. In another COA architecture, DBS electrodes are used for instead of the black matrix to achieve light-shielding, but in this architecture, there is still a low-efficiency liquid crystal region, which is not beneficial to the improvement of contrast.

### SUMMARY OF INVENTION

### Technical Solutions

To solve the above problems, the technical solution provided by the present invention is as follows.

The invention provides a liquid crystal display panel, including:

a first substrate provided with a plurality of scan lines and a plurality of data lines crossing to each other to define a plurality of pixel units, wherein each of the pixel units includes a common electrode, a pixel electrode, and a black matrix replacement electrode, and the black matrix replacement electrode is disposed above the corresponding data line to shield the corresponding data line and insulated from the corresponding data line;

a second substrate aligned with the first substrate, wherein a black matrix is arranged on the second substrate and corresponds to a region between any two adjacent pixel units of the pixel units; and

a liquid crystal layer disposed between the first substrate and the second substrate.

In the liquid crystal display panel provided in the embodiment of the present application, the liquid crystal display panel further including a color resist layer disposed on the first substrate.

In the liquid crystal display panel provided in the embodiment of the present application, the liquid crystal display panel further including a color resist layer disposed on the second substrate.

In the liquid crystal display panel provided in the embodiment of the present application, vertical extension lines on both sides of the black matrix are correspondingly positioned within inner sides of outer edges of the common electrodes on both sides of the data line below the corresponding black matrix.

In the liquid crystal display panel provided in the embodiment of the present application, the vertical extension lines of the both sides of the black matrix are more than 1 micron away from the outer edges of the common electrodes on the both sides of the data line below the corresponding black matrix.

In the liquid crystal display panel provided in the embodiment of the present application, vertical extension lines on both sides of the black matrix are correspondingly positioned within inner sides of outer edges of the common electrodes on both sides of the data line below the corresponding black matrix.

In the liquid crystal display panel provided in the embodiment of the present application, the black matrix replacement electrode and the pixel electrode are formed by a same film formation process and a same photolithography patterning process.

In the liquid crystal display panel provided in the embodiment of the present application, the black matrix replacement electrodes are spaced apart from the pixel electrodes.

In the liquid crystal display panel provided in the embodiment of the present application, material of the black matrix replacement electrode includes indium tin oxide.

In the liquid crystal display panel provided in the embodiment of the present application, the color resist layer includes a plurality of red color resists, a plurality of blue color resists, and a plurality of green color resists.

In the liquid crystal display panel provided in the embodiment of the present application, the color resist layer includes a plurality of red color resists, a plurality of blue color resists, and a plurality of green color resists.

In the liquid crystal display panel provided in the embodiment of the present application, the color resist layer is disposed between the data lines and the pixel electrodes, and is insulated from the data lines and the pixel electrodes.

The present invention also provides a liquid crystal display device including the afore-mentioned liquid crystal display panel.

### Beneficial Effect

The beneficial effects of the present invention are as follows. The present invention provides a liquid crystal display panel, by applying a composite light-shielding structure of a black matrix replacement electrode and a black matrix at the position of a data line routing. An aspect, the black matrix replacement electrode is used to replace the electrodes for electrical control to achieve the light leakage shielding; meanwhile, the black matrix is used to block the low-efficiency liquid crystal region caused by the black matrix replacement electrode, which effectively controls the brightness of the dark field and improves the contrast. Another aspect, under the effect of the black matrix replacement electrode, a width of the black matrix can be controlled to be less than a distance between the common electrodes on both sides of the corresponding data line, thereby effectively ensuring the pixel aperture ratio. That is, the liquid crystal display panel provided by the present invention can be taken into account with the effective aperture ratio and the mixed-color light leakage control function, and significantly improves the contrast.

### BRIEF DESCRIPTION OF FIGURES

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a schematic structural diagram of a liquid crystal display panel in the conventional art provided by the present invention.

FIG. 2 is a schematic structural diagram of another liquid crystal display panel in the conventional art provided by the present invention.

FIG. 3 is a schematic structural diagram of a liquid crystal display panel according to an embodiment of the present invention.

FIG. 4 is a schematic structural diagram of another liquid crystal display panel according to an embodiment of the present invention.

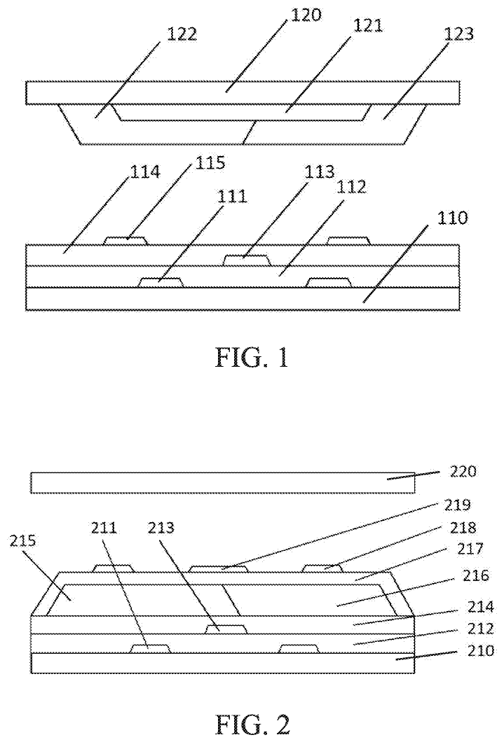

### DETAILED DESCRIPTION OF EMBODIMENTS

The following description of each embodiment, with reference to the accompanying drawings, is used to exemplify specific embodiments which may be carried out in the present invention. Directional terms mentioned in the present invention, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present invention. In the drawings, components having similar structures are denoted by the same numerals.

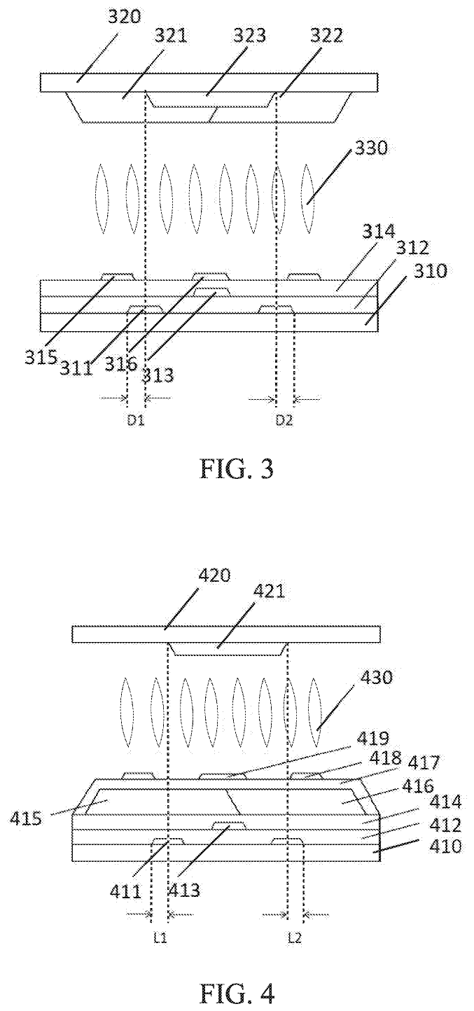

An embodiment of the present invention provides a liquid crystal display panel, please refer to FIG. 3 for details, which will be described in detail below. The liquid crystal display panel includes the following.

The first substrate 310 is provided with a plurality of scan lines (not shown in the figure) for inputting driving signals, and a plurality of data lines 313 for inputting signals to pixel electrodes 315. The plurality of scan lines and the plurality of data lines 313 are disposed crossing to each other to define a plurality of pixel units. Each of the pixel units includes a common electrode 311, a pixel electrode 315, and a black matrix replacement electrode 316, and the black matrix replacement electrode 316 is disposed above the corresponding data line 313 to shield the corresponding data line and insulated from the corresponding data line 313.

Specifically, the first substrate 310 includes the common electrode 311, a first insulating layer 312, the data line 313, a second insulating layer 314, the pixel electrode 315, and the black matrix replacement electrode 316 sequentially disposed from bottom to top.

The second substrate 320 is provided with a color resist layer and a black matrix 323. The color resist layer includes a plurality of color resists positioned in a pixel region. A first color resist 321 and a second color resist 322 are exemplarily shown in FIG. 3, where a black matrix 323 is formed at a boundary between the first color resist 321 and the second color resist 322.

In addition, a liquid crystal layer 330 is disposed between the first substrate 310 and the second substrate 320, and controls the direction of the liquid crystal molecules in the liquid crystal layer 330 by applying electricity or not, and the light of the backlight module is refracted to generate a picture.

Here, a hybrid structure of the black matrix 323 and the black matrix replacement the electrode 316 is adopted, in which the black matrix 323 serves as a physical light-shading function, and the black matrix replacement electrode 316 serves as an electrical control function to shield light leakage. Therefore, the accuracy of the alignment can be improved, which is equivalent to allow a width of the black matrix 323 positioned at the data line 313 to be reduced. In addition, since the black matrix 323 covers the low-efficiency liquid crystal region near the black matrix replacement electrode 316, the contrast is further improved compared with the conventional architecture.

The black matrix replacement electrode according to the present invention is a Data line BM less (DBS) electrode, and has same potential as the common electrode on the second substrate, so that the liquid crystal molecules in this region remain undeflected, playing a role of light-shielding, and the black matrix corresponding to the data line can be replaced.

In the present embodiment, vertical extension lines on both sides of the black matrix 323 are correspondingly positioned within inner sides of outer edges of the common electrodes 311 on both sides of the data line 313 below the corresponding black matrix. This width design can effectively cover the low-efficiency liquid crystal region to improve the contrast, and avoid to affect the aperture ratio when the width is too wide to enter the pixel opening region.

Furthermore, the vertical extension lines on the both sides of the black matrix 323 have distances D1 and D2 away from the outer edges of the common electrodes 311 on the both sides of the data line 313 below the corresponding black matrix, and the distances D1 and D2 are both greater than 1 micron to prevent the aperture ratio and transmittance to decrease caused by an overlay of alignment shift.

In the present embodiment, the vertical extension lines on both sides of the black matrix 323 are correspondingly positioned within the inner sides of the outer edges of the common electrodes 311 on both sides of the data line 313 below the corresponding black matrix to ensure sufficient shielding of the low-efficiency liquid crystal region.

In the present embodiment, the black matrix replacement electrode 316 and the pixel electrode 315 are formed by a same film formation process and a same photolithography patterning process. Specifically, a layer of indium tin oxide film is deposited on the second insulating layer 314 by a physical vapor deposition process, and then, a corresponding pattern is formed through a photolithography process, that is, the black matrix replacement electrode 316 and the pixel electrode 315 are formed, and the black matrix replacement electrode 316 and the pixel electrode 315 are spaced apart from each other.

Another embodiment of the present invention provides a liquid crystal display panel. For details, please refer to FIG. 4, which will be described in detail below. The liquid crystal display panel includes the following.

The first substrate 410 is provided with a plurality of scan lines (not shown in the figure) for inputting driving signals, and a plurality of data lines 413 for inputting signals to pixel electrodes 418. The plurality of scan lines and the plurality of data lines 413 are disposed crossing to each other to define a plurality of pixel units, each of the plurality of pixel units including a common electrode 411, a color resist layer, a pixel electrode 418, and a black matrix replacement electrode 419. The black matrix replacement electrode 419 is disposed above the corresponding data line 413 to shield the corresponding data line 413 and insulated from the corresponding data line 413. The color resist layer includes a plurality of color resists positioned in a pixel region. A first color resist 415 and a second color resist 416 are exemplarily shown in FIG. 4.

Specifically, the first substrate 410 includes the common electrode 411, a first insulating layer 412, the data line 413, a second insulating layer 414, the first color resist 415, the second color resist 416, a third insulating layer 417, the pixel electrode 418, and the black matrix replacement electrode 419 sequentially disposed from bottom to top.

The second substrate 420 is provided with a black matrix 421, the black matrix 421 is formed at a boundary between the first color resist 415 and the second color resist 416.

In addition, the liquid crystal layer 430 is disposed between the first substrate 410 and the second substrate 420, and controls the direction of the liquid crystal molecules in the liquid crystal layer 430 by applying electricity or not, and the light of the backlight module is refracted to generate a picture.

Here, a hybrid structure of the black matrix 421 and the black matrix replacement the electrode 419 is adopted, in which the black matrix 421 serves as a physical light-shading function, and the black matrix replacement electrode 419 serves as an electrical control function to shield light leakage. Therefore, the accuracy of the alignment can be improved, which is equivalent to allow a width of the black matrix 421 positioned at the data line 413 to be reduced. In addition, since the black matrix 421 covers the low-efficiency region of the liquid crystal near the black matrix replacement electrode 419, the contrast is further improved compared with the conventional architecture.

In the present embodiment, vertical extension lines on both sides of the black matrix 421 are correspondingly positioned within inner sides of outer edges of the common electrodes 411 on both sides of the data line 413 below the corresponding black matrix. This width design can effectively cover the low-efficiency liquid crystal region to improve the contrast, and avoid to affect the aperture ratio when the width is too wide to enter the pixel opening region.

Furthermore, the vertical extension lines on the both sides of the black matrix 421 have distances L1 and L2 away from the outer edges of the common electrodes 411 on the both sides of the data line 413 below the corresponding black matrix, and the distances L1 and L2 are both greater than 1 micron to prevent the aperture ratio and transmittance to decrease caused by an overlay of alignment shift.

In the present embodiment, the vertical extension lines on both sides of the black matrix 421 are correspondingly positioned within the inner sides of the outer edges of the common electrodes 411 on both sides of the data line 413 below the corresponding black matrix to ensure sufficient shielding of the low-efficiency liquid crystal region.

In the present embodiment, the black matrix replacement electrode 419 and the pixel electrode 418 are formed by a same film formation process and a same photolithography patterning process. Specifically, a layer of indium tin oxide film is deposited on the third insulating layer 417 by a physical vapor deposition process, and then, a corresponding pattern is formed through a photolithography process, that is, the black matrix replacement electrode 419 and the pixel electrode 418 are formed, and the black matrix replacement electrode 419 and the pixel electrode 418 are spaced apart from each other.

In the present embodiment, vertical extension lines on both sides of the black matrix 419 are correspondingly positioned within inner sides of outer edges of the common electrodes on both sides of the data line 413 below the corresponding black matrix.

In the present embodiment, vertical extension lines on both sides of the black matrix 419 are correspondingly positioned within the both sides of the corresponding black matrix 421.

In addition, a comparative example of the present embodiment is provided. This comparative example provides a liquid crystal display panel, which except for the absence of the structure of the foregoing black matrix 421, the remaining structure is exactly same as the liquid crystal display panel provided by the present embodiment.

Through testing, the absolute aperture ratio of the liquid crystal display panel provided by the present embodiment is 5.2% less than that of the comparative example, but the liquid crystal efficiency is increased by 5.8% compared with the comparative example, which can ensure that the transmittance of the liquid crystal display panel provided by the present embodiment is basically equivalent to that of the comparative example. However, the liquid crystal display panel provided in the present embodiment has a reduced brightness in the dark field due to the reduction in an area of the light transmitting region, that is, it has a higher contrast than the liquid crystal display panel provided in the comparative example.

It should be noted that the above-mentioned embodiment of the liquid crystal display panel only describes the above-mentioned structure. It can be understood that, in addition to the above-mentioned structure, the liquid crystal display panel of the embodiment of the present invention can also include any other necessary structure as required, such as a gate, source/drain electrodes, and an interlayer dielectric layer (ILD), the details are not limited thereto.

For the liquid crystal display panel provided by the embodiments of the present invention, by applying a composite light-shielding structure of a black matrix replacement electrode and a black matrix at the position of a data line routing, in the COA and Non-COA architectures can be taken into account with the effective aperture ratio and the mixed-color light leakage control function, and significantly improves the contrast.

Based on the liquid crystal display panel provided in the foregoing embodiment, a liquid crystal display device is also provided, including the foregoing liquid crystal display panel.

In the above embodiments, the description of each embodiment has its own emphasis. For the parts that are not described in detail in an embodiment, refer to the detailed descriptions of other embodiments above, which will not be repeated here.

The liquid crystal display panel and the liquid crystal display device provided by the embodiments of the present invention have been described in detail above. Embodiments of the present invention have been described, but not intended to impose any unduly constraint to the appended claims. For a person skilled in the art, any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A liquid crystal display panel, comprising:
a first substrate provided with a plurality of scan lines and a plurality of data lines crossing to each other to define a plurality of pixel units, wherein each of the pixel units comprises a common electrode, a pixel electrode, and a black matrix replacement electrode, and the black matrix replacement electrode is disposed above the corresponding data line to shield the corresponding data line and insulated from the corresponding data line;
a second substrate aligned with the first substrate, wherein a black matrix is arranged on the second substrate and corresponds to a region between any two adjacent pixel units of the pixel units; and
a liquid crystal layer disposed between the first substrate and the second substrate.

2. The liquid crystal display panel according to claim 1, further comprising a color resist layer disposed on the first substrate.

3. The liquid crystal display panel according to claim 1, further comprising a color resist layer disposed on the second substrate.

4. The liquid crystal display panel according to claim 1, wherein vertical extension lines on both sides of the black matrix are correspondingly positioned within inner sides of outer edges of the common electrodes on both sides of the data line below the corresponding black matrix.

5. The liquid crystal display panel according to claim 4, wherein the vertical extension lines of the both sides of the black matrix are greater than 1 micron away from the outer edges of the common electrodes on the both sides of the data line below the corresponding black matrix.

6. The liquid crystal display panel according to claim 1, wherein vertical extension lines on both sides of the black matrix are correspondingly positioned within inner sides of outer edges of the common electrodes on both sides of the data line below the corresponding black matrix.

7. The liquid crystal display panel according to claim 1, wherein the black matrix replacement electrode and the pixel electrode are formed by a same film formation process and a same photolithography patterning process.

8. The liquid crystal display panel according to claim 7, wherein the black matrix replacement electrodes are spaced apart from the pixel electrodes.

9. The liquid crystal display panel according to claim 1, wherein material of the black matrix replacement electrode comprises indium tin oxide.

10. The liquid crystal display panel according to claim 2, wherein the color resist layer comprises a plurality of red color resists, a plurality of blue color resists, and a plurality of green color resists.

11. The liquid crystal display panel according to claim 3, wherein the color resist layer comprises a plurality of red color resists, a plurality of blue color resists, and a plurality of green color resists.

12. The liquid crystal display panel according to claim 2, wherein the color resist layer is disposed between the data lines and the pixel electrodes, and is insulated from the data lines and the pixel electrodes.

13. A liquid crystal display device, comprising the liquid crystal display panel according to claim 1.
